(19) United States
(12) Patent Application Publication
(10) Pub. No.: US 2026/0196398 A1
(43) Pub. Date: Jul. 9, 2026

(54) HIGH-TEMPERATURE SUPERCONDUCTING MAGNETS WITH QUENCH DAMAGE RESILIENCY

(71) Applicants: Massachusetts Institute of Technology, Cambridge, MA (US); Commonwealth Fusion Systems LLC, Devens, MA (US)

(72) Inventors: Brian LABOMBARD, Belmont, MA (US); Krishna Kiran Kumar UPPALAPATI, North Billerica, MA (US); Akhdiyor Israilovich SATTAROV, College Station, TX (US)

(73) Assignees: Massachusetts Institute of Technology, Cambridge, MA (US); Commonwealth Fusion Systems LLC, Devens, MA (US)

(21) Appl. No.: 19/129,382

(22) PCT Filed: Nov. 28, 2023
(86) PCT No.: PCT/US2023/081450

§ 371 Date: May 13, 2025

Related U.S. Application Data
(60) Provisional application No. 63/385,262, filed on Nov. 29, 2022.

(51) Int. Cl. H01F 6/06

(52) U.S. Cl. CPC H01F 6/06

(57) ABSTRACT

Techniques are described for improving quench damage resiliency in non-insulated (NI) high temperature superconductor (HTS) magnets. The techniques may include tuning an amount of HTS tape within turns of a winding of an NI-HTS magnet to reduce variation in critical current across the winding, and/or may include adjusting the turn-to-turn resistance of the windings by adjusting turn-to-turn spacing between windings and thereby reduce variations in joule heating between turns during a quench.

### FIELD OF THE INVENTION

This application relates to high-temperature superconductor (HTS) magnets and, more particularly, to high-temperature superconductor magnets with resiliency to damage during a quench event.

### BACKGROUND

Superconductors are materials that have no electrical resistance to current (are “superconducting”) below some critical temperature. For many superconductors, the critical temperature is below 30 K, such that operation of these materials in a superconducting state requires significant cooling, such as with liquid helium or supercritical helium.

High-field magnets are often constructed from superconductors due to the capability of superconductors to carry a high current without resistance. Such superconducting magnets may, for instance, carry currents greater than 5 kA.

### SUMMARY

According to some aspects, a high-temperature superconductor (HTS) magnet is provided including: a coil formed from a plurality of windings, a first winding of the plurality of windings including a first portion of HTS tape that forms less than one complete turn of the coil.

According to some aspects, a high-temperature superconductor (HTS) magnet is provided including: a coil formed from a plurality of windings, the plurality of windings including a first winding formed from a stack of tapes, wherein: the stack of tapes includes a first number of HTS tapes at a first cross-section, the stack of tapes includes a second number of HTS tapes, greater than the first number of HTS tapes, at a second cross-section exterior to the first cross-section around the first winding, and the stack of tapes includes a third number of HTS tapes, less than the second number of HTS tapes, at a third cross-section exterior to the second cross-section around the first winding.

According to some aspects, a high-temperature superconductor (HTS) magnet is provided including: a plurality of plates arranged in a stack that includes a first plate, the first plate including: a spiral channel formed in the first plate having a plurality of turns with a turn-to-turn spacing, the channel including a winding of high temperature superconductor (HTS) material, wherein the turn-to-turn spacing between innermost turns of the spiral channel is smaller than the turn-to-turn spacing between outermost turns of the spiral channel.

According to some aspects, a high-temperature superconductor (HTS) magnet is provided including: a coil formed from a stack of HTS tape, the coil having at least one bend; and at least one additional layer of HTS tape positioned along a portion of the coil to provide the coil having an amount of HTS material which is increased compared with an amount of HTS material in a second, different portion of the coil.

According to some aspects, a high-temperature superconductor (HTS) pancake magnet is provided including: a baseplate formed from a conductive material, the baseplate having a groove with multiple turns; a coil formed from HTS material, the coil positioned within the groove, the coil having multiple turns, wherein the HTS material is positioned within the groove; and wherein a radial distance between adjacent turns of the coil of HTS material is variable.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is an isometric view of a non-insulated (NI) high temperature superconducting (HTS) magnet, according to some embodiments;

FIG. 2A is a cross-sectional view of an illustrative stack of plates in a superconducting magnet taken through lines A-A′ of FIGS. 2B and 2C, according to some embodiments;

FIGS. 2B and 2C depict upper and lower views, respectively, of a plate of a superconducting magnet, according to some embodiments;

FIG. 3 depicts four turns of an illustrative HTS magnet in which the amount of HTS tape is varied around the winding, according to some embodiments;

FIG. 4 depicts an illustrative winding in which an amount of HTS tape is reduced in the innermost and outermost turns of a winding compared with the middle turns of the winding, according to some embodiments;

FIG. 5A is a top view of portions of four turns of a winding in which HTS tapes are added or removed in a stepwise fashion, according to some embodiments;

FIG. 5B is a side view of a portion of a winding in which HTS tapes are added or removed in a stepwise fashion, according to some embodiments;

FIGS. 5C-5E depict an example of a fixed number of tapes being combined to form a winding, according to some embodiments;

FIG. 6 depicts an illustrative winding in which a number of HTS tapes are decreased across all turns of a winding, according to some embodiments;

FIG. 7 depicts cross-sectional views through two different windings, one of which exhibits turn-to-turn resistance grading, according to some embodiments;

FIGS. 8A and 8B depict, respectively, structural plates without, and with, turn-to-turn resistance grading, according to some embodiments;

FIG. 9 depicts a cross-sectional view through a winding that that is arranged with turn-to-turn resistance grading as well as HTS tape grading, according to some embodiments;

FIG. 10 is a three-dimensional graphic of a fusion machine with a cutaway portion illustrating various components of a tokamak, according to some embodiments; and

FIG. 11 depicts a cross-sectional view of the layers of an illustrative coated-conductor HTS tape, according to some embodiments.

### DETAILED DESCRIPTION

A high-field superconducting magnet often comprises multiple electrically insulated cable turns grouped in a multi-layer arrangement. When the superconducting material is cold enough to be below its critical temperature (the temperature below which the electrical resistivity of the material drops to zero), driving the magnet allows current to pass through the superconducting path without losses. In general, a superconducting magnet is capable of carrying a relatively high current density (e.g., a high amount of current per unit volume or per unit cross-sectional area of superconducting material) while also producing a high magnetic field.

Some superconducting magnets may operate within an environment in which there is an external magnetic field (i.e., external to the magnet). If the external field is time varying, eddy currents may be induced within the superconducting magnet, which may in turn generate current in excess of the transport current for which the magnet is designed. These ‘overcurrents’ may cause some of the superconductor to exceed its critical current limit, which may cause the superconductor to exceed its critical temperature and act as a normal conductor, causing a quench of the magnet.

High temperature superconductors (HTS) can be advantageous in superconducting magnets as they remain superconducting at higher temperatures than low temperature superconductors, and thus do not need to be cooled to as low of a temperature to remain superconducting. Moreover, there may be a greater window of operational temperatures in which a quench can be avoided. As referred to herein, the phrases “HTS materials” or “HTS superconductors” refer to superconducting materials having a critical temperature above 30° K at zero self-field. One example of an HTS material is rare-earth barium copper oxide (REBCO). An HTS magnet is a magnet that includes one or more HTS materials arranged to carry at least a portion of the current of the magnet.

One type of HTS magnet is a non-insulated (NI) HTS magnet in which an electrically conductive and non-superconducting material is arranged between turns of the magnet. An NI-HTS magnet design may comprise a stack of conductive plates having one or more grooves provided therein. An HTS material can be arranged (e.g., wound) within the one or more grooves and the plates stacked such that the superconductor forms a continuous current path through the plates, making a spiral path within and/or between plates (e.g., alternating inner to outer windings and outer to inner windings in successive plates within the stack). The conductive plates act as the conductive material that is arranged between the turns of the HTS material. Thus, adjacent turns of the HTS material are not insulated from one another but are instead separated by a conventional conductor (i.e., not a superconductor) and thus magnets formed with such stacked plates are referred to as a NI-HTS magnet. When the magnet is operating below the critical temperature of the HTS material, current flows through the HTS material and not across turns because the superconductor has zero resistance compared with the finite resistance of the conductor that lies between the turns.

Such a stacked-plate magnet design has the advantage that it is scalable to large bore magnets, and can be configured to have a high overall current density, be thermally stable, and mechanically stable.

During a quench, at least one or more portions of the superconductor may be in a “normal” (non-superconducting) state (i.e., at least one or more portions of the superconductor have a finite resistance rather than a zero resistance which is characteristic of a superconductor). The at least one or more portions of the superconductor having a normal resistance are sometimes referred to as “normal zones” of the superconductor. When normal zones appear, at least some zero resistance current pathways may no longer be present, causing the current to flow through the normal zones and/or between the turns, with the balance of current flow between these pathways depending on their relative resistances. By diverting at least some current from the superconducting material when it is normal in this manner, therefore, NI magnets, and in particular non-insulated high temperature superconductor (NI-HTS) magnets (NI magnets that comprise HTS), can in principle be passively protected against quench damage without the need to continuously monitor quench events and/or to actively engage external quench protection mechanisms.

NI-HTS magnets exhibit a unique response during quench—the magnetic energy is dissipated within the winding pack and mechanical structure of the magnet itself. Thus, in principle, NI-HTS magnets can be designed to be passively protected against quench damage, even at high stored magnetic energy.

Stacked-plate, HTS magnets have considerable flexibility in design to attain quench resiliency through the choice of HTS conductor arrangement, base plate, co-wind and auxiliary conductors, as well as the materials used. For example, an electrically conductive ‘co-conductor’ that is thermally and electrically well-connected to the baseplate can be effective in enhancing quench stability and protecting the magnet should it quench. However, as the stored energy per unit volume increases, there are situations in which these techniques alone are not sufficient to avoid damage. This is because the quench can initiate and propagate in unfavorable ways, depending on the arrangement of the superconducting tapes and the arrangement of the critical current distribution within the magnet.

In accordance with the concepts described herein, the inventors have recognized and appreciated that two phenomena in particular can restrict the quench-safe operational space for NI magnets, either or both of which can result in grinding or crushing forces that can damage the stacked plates when a quench occurs. The first of these phenomena is the development of one or more azimuthally localized, radially connected normal zones. That is, during a quench, a normal zone may develop in several adjacent turns, centered around a particular azimuthal region. These regions may consequently exhibit a lower critical current within short azimuthal spans of a winding, with the lower critical current being similar in adjacent turns. This can result in a concentrated region of heating that may damage the magnet. The inventors have recognized and appreciated that spatial variation of the critical current of the current path, both along and across the windings, in the magnet may be the root cause of this phenomenon.

The second such phenomena is high Lorentz I×B body loads on the magnet structure due to current peaking. When the magnet begins to quench, the turns of the coil heat up and shed current. When the turns of the magnet exhibit different critical currents, however, the turns do not shed current at the same time, with turns exhibiting a lower critical current shedding current first. In addition, turns exhibiting a higher critical current increase their current to conserve magnetic flux flowing through them. This leads to a cascade with turns holding onto the current until they quench, then releasing it into neighboring turns via inductive coupling. Eventually, the current cascades into the turns exhibiting the highest critical current, which can produce very high currents (e.g., several times that of the terminal current). These high currents can produce very high Lorentz forces that could damage the mechanical structure of the magnet (e.g., the conventional conductor forming the stack of pancakes).

In accordance with a further aspect of the concepts described herein, the inventors have recognized and appreciated a non-insulated (NI) HTS magnet design which employs “HTS tape grading” and/or “turn-to-turn resistance grading” techniques to increase (and ideally, maximize) quench damage resiliency for high energy density, no insulation superconducting magnet designs.

In particular, HTS tape grading may have an effect of reducing the variation of the critical current across the windings of the magnet. The inventors have recognized and appreciated that the critical current in the windings of an HTS magnet may vary strongly as a function of turn number, and may also vary significantly within a given turn. As noted above, this introduces a risk of an azimuthally localized, radially connected normal zone developing in adjacent turns during a quench, which is unfavorable as it creates a localized hot spot that extends across multiple adjacent turns. In a non-insulated magnet, current can often navigate around a local defect such as a normal zone by flowing into an adjacent turn. However, when a normal zone extends over multiple adjacent turns, current may be forced to flow through the normal zone, despite it having a high resistance.

By applying the HTS tape grading techniques described herein, the variation in critical current within a magnet may be reduced, which reduces the magnitude of current peaking (and thereby localized heating) that occurs during a quench. That is, during a quench, increases in current may be more uniform when HTS tape grading is employed. HTS tape grading may, for example, allow an HTS magnet to be configured such that a large number of turns of the magnet will quench simultaneously, rather than a quench including one or more localized regions of high current.

In some embodiments, a superconducting magnet may comprise windings of HTS tape that include a stack of HTS tapes and co-wind tapes (where co-wind tapes do not comprise HTS material, but rather are provided from non-superconducting materials such as copper or conductive nickel alloy, for example) disposed in a structural groove (e.g., a grooved plate). In some embodiments, the stack of HTS tapes and co-wind tapes (e.g., copper co-wind tapes) may be soldered together to form a composite conductor. With tape grading, the amount of HTS tape (e.g., number of HTS tapes or more generally the amount of HTS material) and/or copper co-wind tapes in the stack is varied with distance (e.g., winding distance, radial position, etc.) along the winding, which may include increases and/or decreases of the number of HTS and/or co-wind tapes at multiple points within the windings. For instance, along a winding within a structural plate, the number of HTS and/or co-wind tapes at one point in the winding may be greater than, or less than, the number of HTS and/or co-wind tapes at a different point in the winding. In some embodiments, the amount of HTS tape in a winding is varied by changing the size of the stack of HTS tape (e.g., introducing or removing HTS tape along the winding).

In some embodiments, the amount of HTS tape in a winding is varied by substituting HTS tape for a non-HTS tape (e.g., copper or conductive nickel alloy tape) in regions around the windings. Such a non-HTS tape may be spliced end-to-end with the HTS tape, and in some cases may produce a stack of tapes that is formed from a constant number of tapes, with HTS tape or non-HTS tape being present at each point in this stack.

The tape grading technique can be applied to reduce (and ideally minimize) HTS tape usage and, in general, allows for a customization of a critical current map associated with a particular magnet. This may include utilizing the tape grading technique described here to customize a critical current map of a magnet such that the critical current map is more uniform (or in some cases substantially uniform) across the windings and/or within each winding. As will be described in detail further below, HTS tape may be added and/or removed from certain portions of a winding (e.g., a winding arranged within a groove in a structural plate) to increase or decrease an amount of HTS tape compared with an amount of HTS tape that would be used in conventional techniques.

According to some embodiments, a superconducting magnet that is graded according to the techniques described herein may comprise a stack of HTS tapes arranged in a winding, wherein the amount of HTS tape in the stack varies with radial distance from the center of the winding. For instance, a winding of HTS tapes arranged within a spiral groove of a structural plate may include less HTS tapes in the winding at some radial positions compared with other radial positions. As one example, inner turns of the winding may comprise comparatively fewer HTS tapes in the stack compared with middle or outer turns of the winding. As another example, outer turns of the winding may comprise comparatively fewer HTS tapes in the stack compared with middle or inner turns of the winding. As yet another example, outer turns of the winding may comprise comparatively fewer HTS tapes in the stack compared with middle turns of the winding, and inner turns of the winding may comprise comparatively fewer HTS tapes in the stack compared with the middle turns of the winding.

It has been recognized by the inventors that critical current can be higher within comparatively tighter turning regions (e.g., smaller radius of curvature) of a single winding. By reducing the amount of HTS tape in such regions, the critical current across the winding may be made more uniform. According to some embodiments, therefore, regions of a winding with a comparatively smaller radius of curvature may comprise comparatively less HTS tape than other regions of the same winding that have a comparatively larger radius of curvature.

It may be noted that varying the amount of HTS tape in a single winding may, in at least some instances, employ pieces of HTS tape that do not wind fully around a single winding of a magnet. That is, when a winding comprises a stack of HTS tapes that varies in the number of HTS tapes around the winding, some of those HTS tapes may not reach the outermost end and/or may not reach the innermost end of the winding, and may include one or two ends arranged somewhere within the interior of the winding. In some cases, a piece of HTS tape may have a length less than one full turn of the winding, in which case both ends of that piece of HTS tape would be arranged within a single turn of the winding. In some cases, a first piece of HTS tape may be arranged with a first number of turns within a winding, and a second piece of HTS tape may be arranged with a second number of turns within the same winding, where the first and second number of turns are different.

According to some embodiments, a superconducting magnet that is graded according to the techniques described herein may comprise a stack of structural plates each comprising a winding of HTS tapes arranged in a spiral groove. The number of HTS tapes at a given position within the winding may be varied based on the position of the structural plate within the stack of structural plates. For instance, a winding of HTS tapes arranged within a first structural plate may comprise more, or less, HTS tapes in its winding compared with a second, different, structural plate in the magnet. In some cases, the number of HTS tapes in this manner may be varied in a constant manner across a winding (e.g., a winding in one plate may comprise the number of HTS tapes in another winding but reduced by a constant number of HTS tapes across the whole winding). For example, a winding within the middle of a stack of windings may exhibit a constant number of HTS tapes within its winding, where that number of HTS tapes is less than the number of HTS tapes in another winding in the stack. Additionally, or alternatively, a winding in a stack of windings may comprise a number of HTS tapes that is varied selectively within the winding (e.g., one winding may comprise fewer HTS tapes in total than another winding, wherein one portion of the winding exhibits a greater difference in the number of HTS tapes compared with the other winding than another portion of the winding). As one example, it has been noted that the middle windings in a stack of windings may heat up faster than other turns in the stack. As such, it may be advantageous to reduce the amount of HTS tape in the middle windings in the stack (or equivalently, increase the amount of HTS tape in the outermost windings in the stack) to create a more uniform response across the windings in the stack during a quench.

With respect to turn-to-turn resistance grading, it has been observed by the inventors that turns within a coil may not quench at the same time. As described above, a localized quench may be undesirable because it creates hot spots across turns within only part of the magnet. The inventors have recognized and appreciated that in a superconducting magnet comprising a superconductor winding, the innermost turns of the winding may quench prior to the outermost turns. This may be the case even in a superconducting magnet in which tape grading, described above, has been employed to produce a consistent critical current across the windings. This quench behavior may result from a lack of consistency in joule heating across the turns, even with a constant critical current.

Without wishing to be bound by theory, the inventors have recognized that the lack of consistency in joule heating may be caused by inconsistent resistances across the turns of a magnet. In a stacked plate magnet design, turn-to-turn resistance is largely determined by turn-to-turn groove spacing since this determines the extent to which there is normal conductor between turns. As a result, by adjusting the spacing of the plate grooves (which also adjusts the spacing between the turns), the turn-to-turn resistance can be adjusted (or ‘graded’). For example, since the innermost turns are expected to quench prior to the outermost turns, this suggests that joule heating is higher in the inner turns, and therefore by reducing the resistance between the inner turns, the joule heating may be made more consistent across the turns.

According to some embodiments, a superconducting magnet may comprise a stack of structural plates each comprising a winding of HTS tapes arranged in a spiral groove, wherein the groove is arranged so that a distance between adjacent turns is not constant across the spiral. This distance may be measured along any suitable axis from a center or central region of a structural plate to the outer boundary of the plate. For example, the distance may be measured radially from a center of the plate. Irrespective of along which axis the distance is measured, in some cases the distance between turns of the spiral groove in a plate may be smallest between the innermost two turns and largest between the outermost two turns. In some cases, the distance between turns of the spiral groove may gradually increase from the innermost turns to the outermost turns (i.e., the distance between each pair of adjacent turns is larger than the distance between the neighboring pair of adjacent turns that is closer to the center of the spiral groove).

Following below are more detailed descriptions of various concepts related to, and embodiments of, magnet designs employing tape grading and/or turn-to-turn resistance grading techniques. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

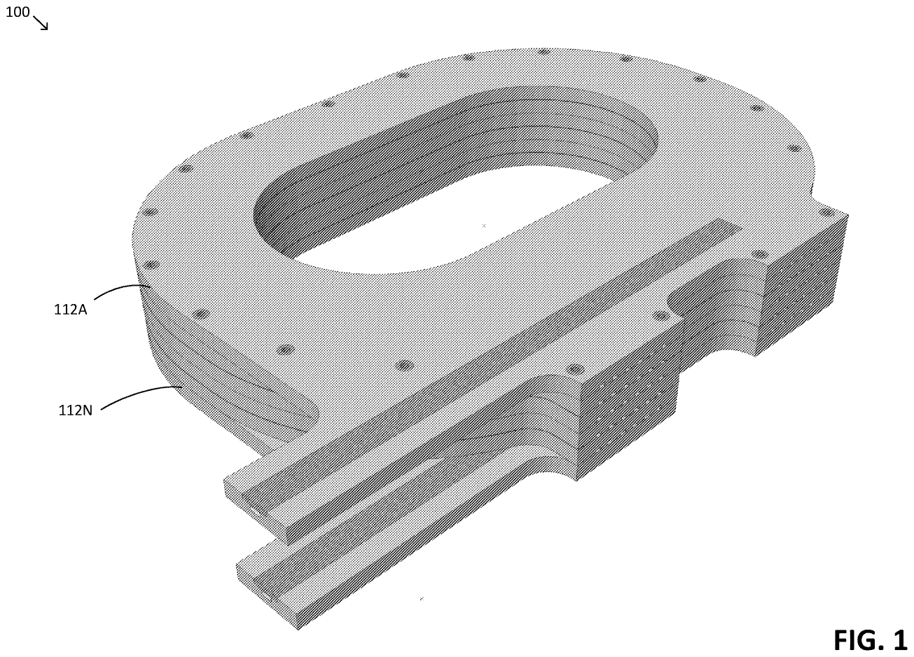

Referring to FIG. 1, a non-insulated (NI) high temperature superconductor (HTS) magnet 100 comprises a plurality of base plates 112A through 112N having grooves provided therein with HTS material disposed in the grooves (grooves and HTS material not visible in FIG. 1). HTS magnet 100 may be configured based on the above-described tape grading and/or turn-to-turn resistance grading techniques to produce an HTS magnet with greater quench damage resiliency compared with that of conventional HTS magnet designs. As described above, tape grading and/or turn-to-turn resistance grading are both techniques that may be applied to provide the HTS magnet 100 with an increased (and ideally maximized) quench damage resiliency characteristic.

In some embodiments, magnet 100 may comprise grooved, stack-plate, D-shaped base plates in which HTS tapes (or tape stack or bundles) are disposed. In some embodiments, a magnet may comprise 16 baseplates, with each baseplate comprising a winding having 16 turns comprising HTS material. In the example of FIG. 1, several baseplates 112A-112N are depicted as an illustrative example. In some embodiments, at least some of the baseplates 112A-112N may comprise grooves having a so-called race-track shape, although grooves may also be configured with any other suitable shape (e.g., any regular or irregular geometric shape).

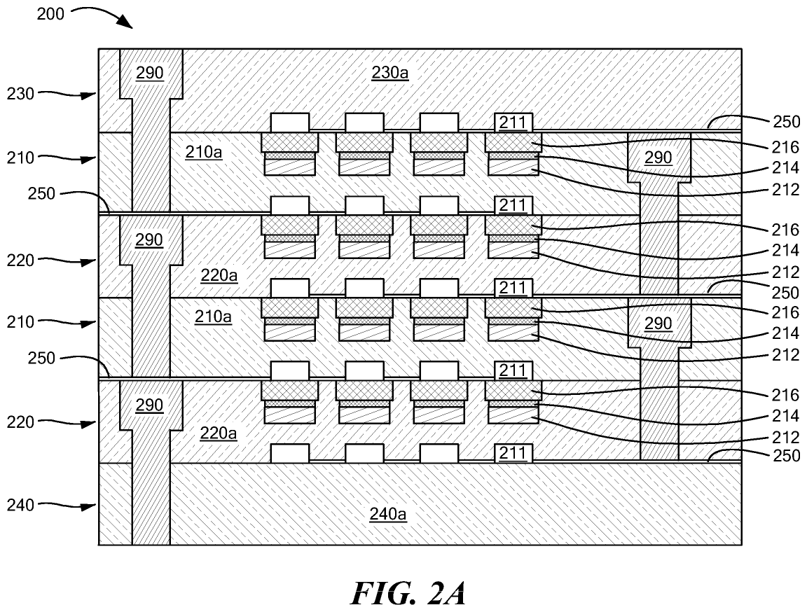

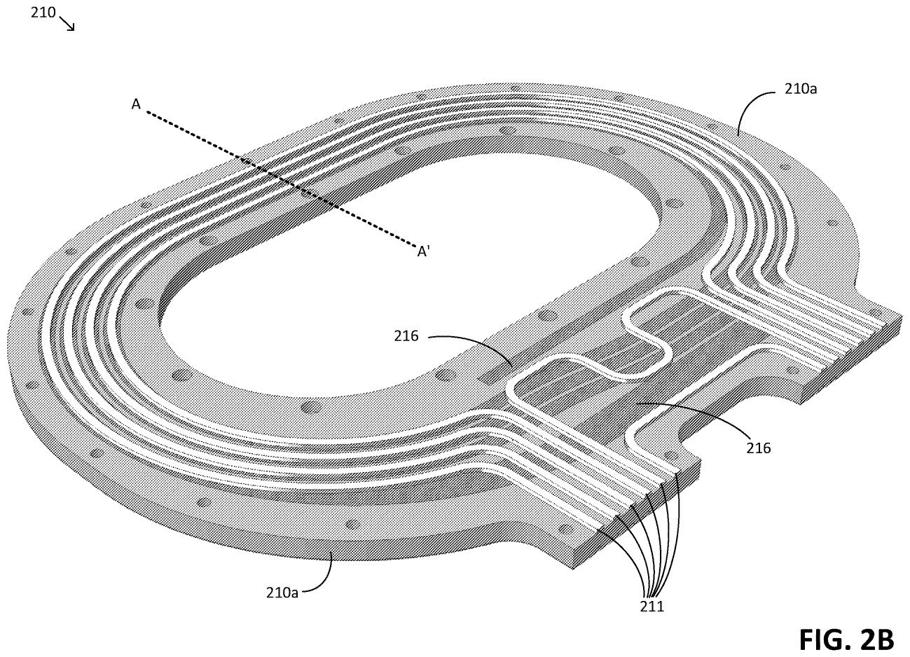

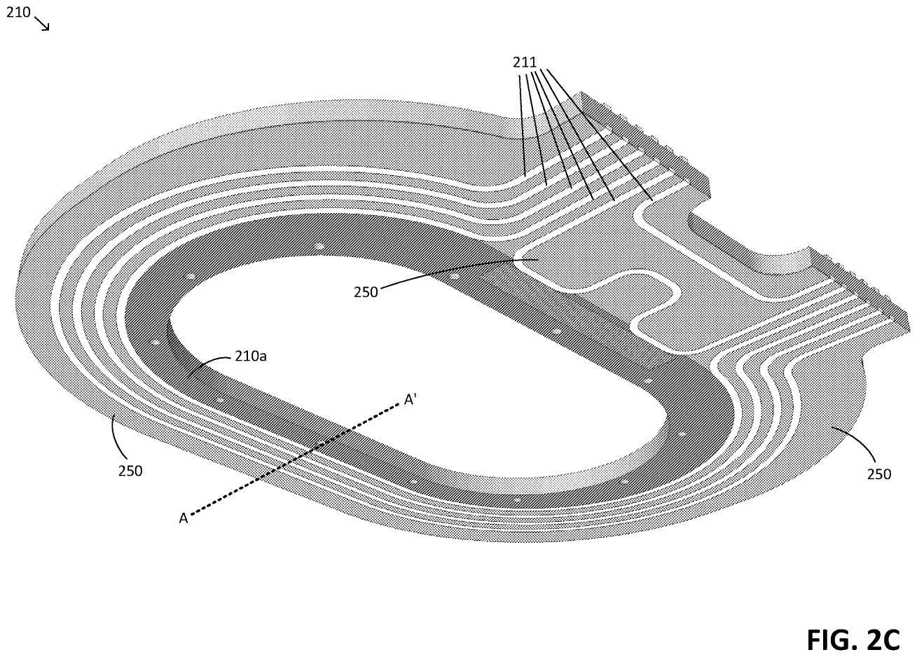

FIGS. 2A-2C depict aspects of an illustrative implementation of the base plates shown in FIG. 1, according to some embodiments. In particular, FIG. 2A shows a cross-section of an illustrative stack of plates in a superconducting magnet, according to some embodiments. Stack of plates 200 comprises two instances of a plate 210 and two instances of a plate 220, in addition to terminal plates 230 and 240. Layers of insulating material 250 are arranged at selected regions between neighboring plates. FIG. 2A represents a cross-section of the stack of plates through a portion of the plates, which is shown as cross-section A-A′ in FIGS. 2B-2C.

The plates each comprise a baseplate material 210a, 220a, 230a or 240a, in which are formed (e.g., via traditional machining processes, via additive and/or subtractive processes, etc.) cooling channels 211 and conducting channels that comprise an HTS material 212, a cap 216, and an intervening conductive material 214 which provides electrical and thermal contact between the HTS material 212 and cap 216.

According to some embodiments, the baseplates 210, 220, 230 and 240 may comprise, or may consist of, a baseplate material 210a, 220a, 230a and 240a, respectively, which is a high mechanical strength material such as but not limited to steel, Inconel®, Nitronic® 40, Nitronic® 50, Incoloy®, or combinations thereof. In some embodiments, a baseplate material 210a, 220a, 230a or 240a may be plated with a metal such as nickel to facilitate adhesion of other components to the plate, including solder as described below.

According to some embodiments, the HTS material 212 may comprise a rare earth barium copper oxide superconductor (REBCO), such as yttrium barium copper oxide (YBCO). In some embodiments, the HTS material 212 may comprise a co-wound stack of HTS tape.

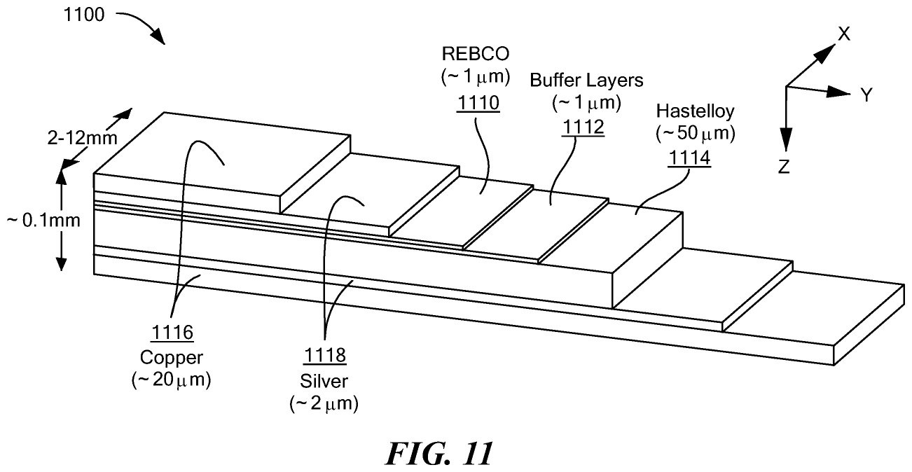

As used herein, “HTS tape” refers to a long, flat element that comprises a layer of HTS material (e.g., polycrystalline HTS) in addition to other layers. In some embodiments, HTS tape may refer to any structure that includes a layer of an HTS, such as a rare-earth cuprate HTS (e.g., REBCO), and which may also contain one or more other layers such as one or more buffer layers, stabilizing layers, substrates, overlay layers and/or cladding layers, such as tape 1100 shown in FIG. 11.

For purposes of illustration, FIG. 11 depicts a cross-sectional view of the layers of an illustrative coated-conductor HTS tape, according to some embodiments. The below description may, in some embodiments, apply to the above discussed HTS tapes arranged within a magnet or magnet assembly. FIG. 11 is an example of an HTS tape 1100 that is fabricated as a coated conductor, wherein the HTS layer 1110 is a layer of REBCO. As noted above, “REBCO” is an acronym for “rare-earth barium copper oxide.” As used herein, in at least some cases “REBCO” may be used to refer more generally to any rare-earth cuprate HTS. As such, unless expressly stated otherwise, barium may be present in REBCO, but is not required to be present. Nonetheless, in the example of FIG. 11 the REBCO layer is provided as one example of an HTS layer and is not intended to limit the illustrated structure to the use of any particular HTS.

In the example of FIG. 11, the illustrative tape 1100 also includes a buffer layer 1112, a Hastelloy® layer 1114, and copper and silver layers 1116 and 1118, respectively, which are arranged both above and below the REBCO layer. The copper layer is sometimes referred to as a “stabilizer” layer. Illustrative dimensions of the tape are shown in FIG. 11, with the tape having a width (size in the X direction) of around 2-12 mm and a thickness (size in the Z direction) of around 0.1 mm.

In some embodiments, an HTS tape may have an aspect ratio (being the ratio of the tape's width to its thickness) that is greater than or equal to 10, 20, 40, 60, 80, 100, 120 or 150. In some embodiments, the HTS tape may have an aspect ratio that is less than or equal to 150, 120, 100, 80, 60, 40, 20 or 10. Any suitable combinations of the above-referenced ranges are also possible (e.g., an aspect ratio of greater than or equal to 60 and less than or equal to 100).

In some embodiments, an HTS tape may have a thickness greater than or equal to 0.005 mm, 0.01 mm, 0.05 mm, 0.1 mm, 0.15 mm, or 0.2 mm. In some embodiments, the HTS tape may have a thickness less than or equal to 0.5 mm, 0.2 mm, 0.15 mm, 0.1 mm, 0.05 mm, or 0.01 mm. Any suitable combinations of the above-referenced ranges are also possible (e.g., a thickness of greater than or equal to 0.01 mm (or about 0.01 mm) and less than or equal to 0.1 mm (or about 0.1 mm)).

In some embodiments, a superconducting magnet such that shown in FIGS. 2A-2C may comprise an HTS tape that is wound around a winding axis such that the x-axis of the tape as shown in FIG. 11 is aligned parallel to the winding axis. In the case of a non-insulated magnet design, for instance, HTS tapes may therefore contact the face (the x-y plane in FIG. 11) of adjacent tapes. In some embodiments, the superconducting magnet may comprise windings of a stack of HTS tapes along with a non-superconducting electrically conductive material, such as steel or copper. For example, a stack of 10-20 HTS tapes stacked face-to-face on top of one or more copper tapes having the same width (size in the x direction in FIG. 11) as the HTS tape may be wound together within a spiral groove of a baseplate.

A stack of HTS tapes may comprise one or more lengths of HTS tape that have cross-sectional dimensions in the range of about 0.001 mm to about 0.1 mm in height or thickness (i.e., size in the z-axis dimension as shown in FIG. 11) and a width in the range of about 1 mm to about 12 mm (x-axis dimension as shown in FIG. 11), that extends along a length of the tape (y-axis dimension in FIG. 11). In some embodiments, HTS tape may comprise a polycrystalline HTS and/or may have a high level of grain alignment. HTS tape stacks may comprise a plurality of HTS tapes arranged on top of one another along the width and length directions. An HTS tape stack may thereby have a thickness equal to (or approximately equal to) the thickness of an individual tape multiplied by the number of tapes in the stack.

According to some embodiments, cap 216 may comprise, or may consist of, copper. It may be noted that, as a result of the baseplates 210, 220, 230 and 240 being shown in cross-section in FIG. 2A, that the shapes of the HTS 212 in the baseplates, and of the cap 216 in the baseplates, are generally that of a spiral (e.g., a racetrack spiral).

According to some embodiments, conductive material 214 may comprise a Pb and/or Sn solder. In some embodiments, conductive material 214 may comprise a metal having a melting point of less than 200° C., wherein at least 50 wt % of the metal is Pb and/or Sn, and at least 0.1 wt % of the metal is Cu.

As shown in FIG. 2A, the caps 216 are arranged within an upper section of channels that is wider than the lower section in which the HTS 212 and conductive material 214 are located. In some embodiments, the conductive material 214 may be introduced into the baseplates 210, 220, 230 and 240 as a molten solder subsequent to arranging the HTS 212 and cap 216 within the conducting channels. As a result, the conductive material 214 may fill the space between the HTS 212 and cap 216 and/or may fill any space around the sides of the HTS 212 and/or cap 216, should such space be present prior to filling or otherwise occupying the space with the solder.

In some embodiments, the HTS 212 may be pre-tinned with a metal (e.g., a PbSn solder) to promote a good bond between the HTS 212 and the solder. According to some embodiments, the conductive material 214 may be deposited via a vacuum pressure impregnation (VPI) process. Such a process may comprise one or more of the following steps: cleaning the empty space within the cable using an acidic solution following by a water rinse; evacuating the space within the cable; purging the space with an inert gas; depositing flux into the space to coat the HTS 212 and the conductive material 214; draining any excess flux from the cable; heating the cable to a temperature below, at, or above a temperature at which the alloy to be deposited will melt; and flowing a molten alloy (e.g., a PbSn solder) into the plate.

According to some embodiments, insulating material 250 may comprise polyimide (e.g., Kapton®), epoxy resin, phenolic resin, glass epoxy laminate, a plastic, an elastomer, or combinations thereof. According to some embodiments, insulating material may have a breakdown voltage or dielectric strength of greater than 25 kV/mm, of greater than 50 kV/mm, of greater than 75 kV/mm, of greater than 100 kV/mm. In some cases, the voltages in the superconducting magnet may be comparatively low, in which case a low voltage standoff insulating material such as anodized aluminum could be utilized as the insulating material 250.

According to some embodiments, plates 210 may comprise one or more through holes for attaching the plate to other plates and/or other structures. In some cases, the through holes may comprise an interior thread to facilitate insertion of mechanical fasteners such as screws or bolts 290 into or through the plate.

In the example of FIG. 2A, open cooling channels in one of the plates are arranged adjacent to the conducting channel of the neighboring plate. For example, as shown in FIG. 2A, the cooling channels 211 in each instance of plate 210 are arranged adjacent to the cap 216 of the neighboring plate 220. In the example of FIG. 2A, the plates 210, 220, 230 and 240 are held together, at least in part, by bolts 290, which connect neighboring pairs of plates. It may be presumed that such bolts are present at a number of locations around the plates 210, 220, 230 and 240.

Baseplate 210 shown in FIG. 2A is shown in further detail in FIGS. 2B and 2C. FIGS. 2B and 2C depict upper and lower views, respectively, of plate 210, wherein the cross-section of FIG. 2A is through the section marked A-A′. In the example of FIGS. 2B-2C, the location of cooling channels 211 that are part of plate 220 arranged above the plate 210, are shown for purposes of explanation, although it will be appreciated that these cooling channels are not in fact part of the plate 210. As may be noted, the conducting channel of plate 210 in this example has an inward spiral when following the channel in a clockwise direction viewed from above.

FIG. 2C illustrates the underside of plate 210, and includes portions to which insulating material 250 is attached, and portions for which the baseplate 210a is exposed.

As described above, two ways in which the quench behavior of a magnet such as the magnet shown in FIGS. 2A-2C may be improved are through tape grading and/or turn-to-turn resistance grading. Illustrative examples of each of these are described below with respect to the illustrative magnet of FIGS. 2A-2C, beginning with tape grading techniques.

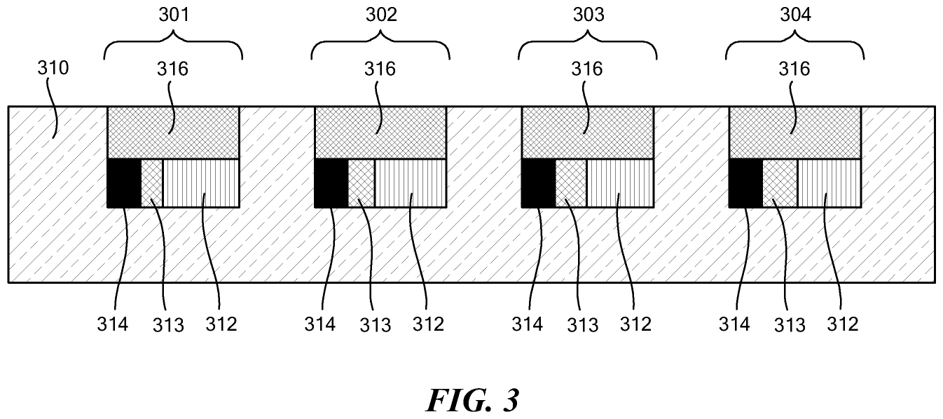

As described above, HTS tape grading techniques may include varying the amount of HTS tape around a winding, which may include varying the number of HTS tapes in a stack of HTS tapes, and/or may include substituting HTS tape for a non-HTS tape around the windings. FIG. 3 depicts four turns 301, 302, 303 and 304 of an illustrative HTS magnet in which the amount of HTS tape is varied, according to some embodiments. In the example of FIG. 3, a baseplate 310 comprises a spiral conducting channel, four turns of which are shown in the drawing. The channel comprises a stack of tapes 312 which comprises HTS tapes, alongside a co-conductor 313, with an electrically conductive cap 316 arranged over the HTS tapes and co-conductor. A solder 314 is deposited to fill space between the co-conductor and the cap. The stack of HTS tapes in FIG. 3 is represented as a plurality of tapes arranged on their side and being directed into the page. As shown in FIG. 3, the number of tapes in the stack of HTS tapes 312 may vary such that there are more tapes in turn 301 (at least in the cross-section of turn 301 shown in FIG. 3) than in turns 302, 303 or 304. Similarly, turn 302 includes a greater number of tapes in the stack of HTS tapes 312 than in turn 303 or 304, and turn 303 includes a greater number of tapes in the stack of HTS tapes 312 than in turn 304. Together the stack of tapes 312, the co-conductor 313, solder 314 and cap 316 form a winding within the spiral channel.

As may be noted, the amount of co-conductor 313 may also vary when the number of HTS tapes in the stack varies, as shown in FIG. 3. For example, there is a greater amount of co-conductor 313 in turn 304 than in turns 301, 302 or 303.

According to some embodiments, the co-conductor 313 may comprise, or may be formed by, a plurality of conventionally conductive (i.e., not superconductor) tapes. For instance, co-conductor 313 may comprise a stack of copper tapes (or tapes of some other metal), being long, flat conductive structures having similar (or identical) cross-sectional dimensions as the HTS tapes. When implemented in this manner, one way to vary the amount of co-conductor 313 around the turns of a winding is to vary the number of conventionally conductive tapes in the winding. Although one way to vary the number of conventionally conductive tapes and HTS tapes around a winding is to increase one number while the other decreases by the same number, thereby having a constant (or approximately constant) number of tapes in total (i.e., the number of co-conductor tapes plus the number of HTS tapes), windings in which the number of tapes in each of the two stacks is varied independently may also be implemented. In some embodiments, the total size of the stack of tape (being a combination of the HTS tapes and the co-conductor tapes) may remain constant, which the balance between co-conductor tape and HTS tape varies.

According to some embodiments, a stack of HTS tapes arranged as HTS 212 in the example of FIG. 2A may also be varied in the same manner shown in FIG. 3. For instance, although not shown in FIG. 2A, the HTS 212 may comprise a stack of HTS tapes arranged on their side and stacked left to right in the drawing, in the same manner as the tapes more explicitly shown in FIG. 3, and the amount of HTS tape in this stack may be varied around the winding.

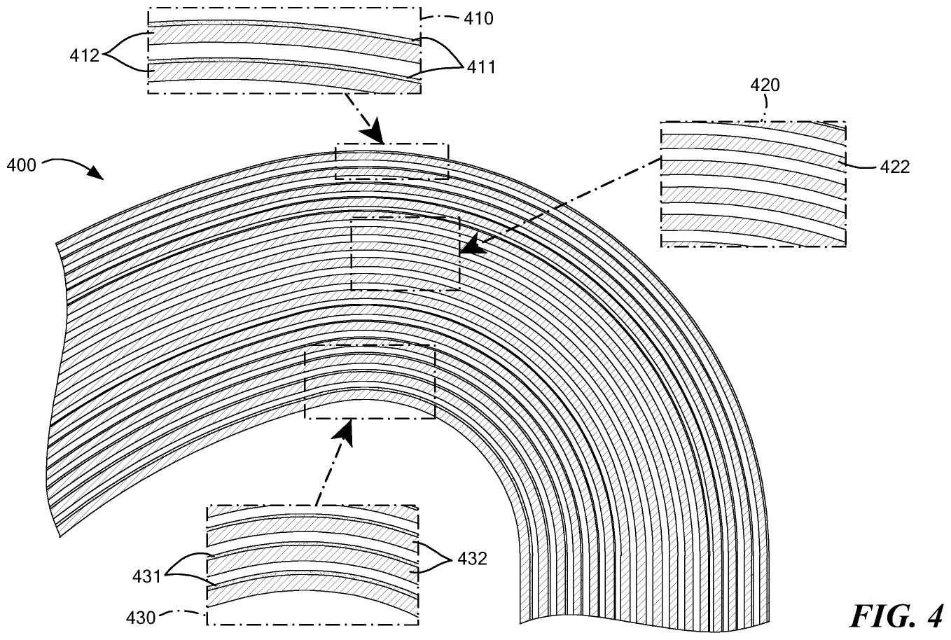

According to some embodiments, the manner in which the amount of HTS tape in a stack of tapes is varied within a winding may be different in different windings in a stack of windings. For example, in the illustrative magnet formed from four windings shown in FIG. 2A, the number of HTS tapes in a stack used to form HTS material 212 may be different in some windings (e.g., the top or bottom windings) versus other windings (e.g., the middle windings). These differences may be in the absolute number of HTS tapes and/or how that number is varied with distance along the winding. FIGS. 4 and 6 depict illustrative examples of two ways in which the amount of HTS tape in a stack of HTS tapes can be varied.

FIG. 4 depicts an illustrative winding in which an amount of HTS tape is reduced in the innermost and outermost turns of a winding compared with the middle turns of the winding, according to some embodiments. It has been recognized by the inventors that the critical current in a winding may be higher along the innermost turn or turns of the windings and the outermost turn or turns of the windings. As described above, one goal of HTS tape grading is to produce a consistent critical current across the windings. As such, in regions where the critical current is higher, it may be beneficial to arrange less HTS tape in those regions to produce a ‘flat’ critical current map across the winding. FIG. 4 is an example of such an approach, which shows a constant amount of HTS tape around the entire winding (encompassing the regions shaded with diagonal lines, and the regions shaded with dots) before grading, and shows a reduced amount of HTS tape in the regions shaded with diagonal lines only, after grading. Close-ups of parts of the winding 400 are shown in insets 410, 420 and 430 for purposes of illustration, which are not drawn to the same scale as one another.

As shown by the inset 410 of FIG. 4, the amount of HTS tape in the outermost two windings is reduced compared with the pre-grading example, while the amount of HTS tape in the middle winding remains the same (as shown in inset 420). For example, an excess of tape 411 may be seen around the sides of the graded tape stack 412, whereas no such excess is shown around graded tape stack 422, which contains the same amount of HTS tape as in the pre-graded tape stack.

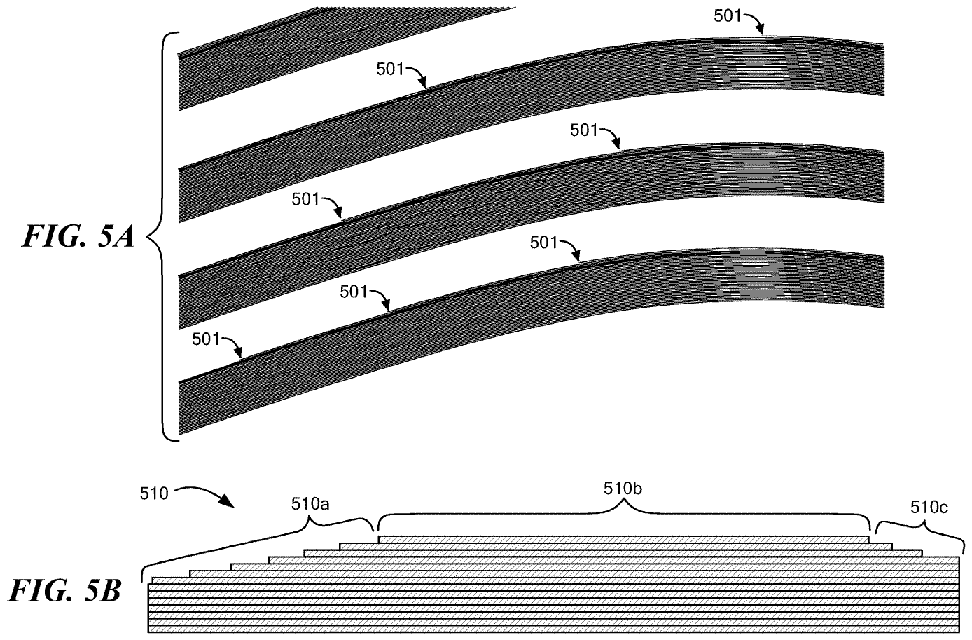

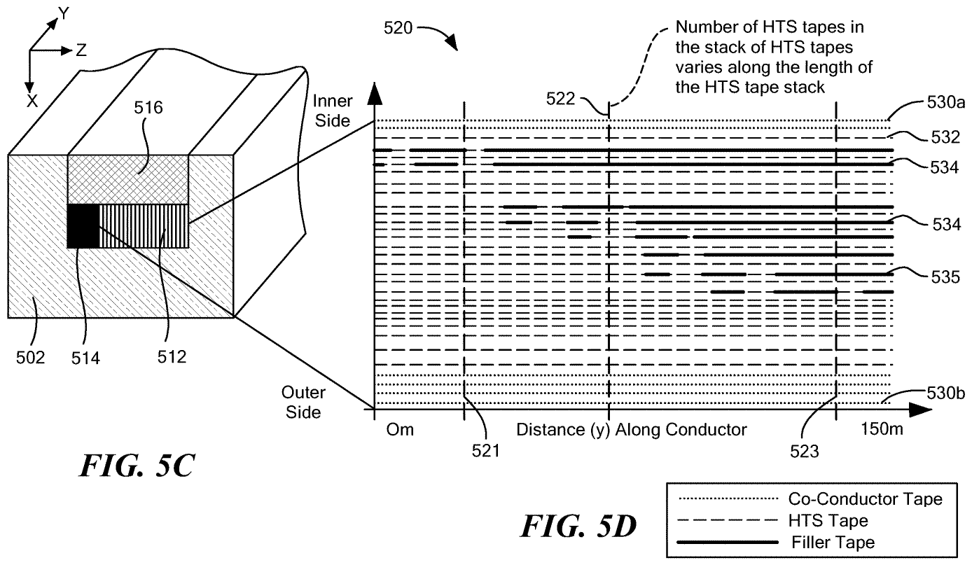

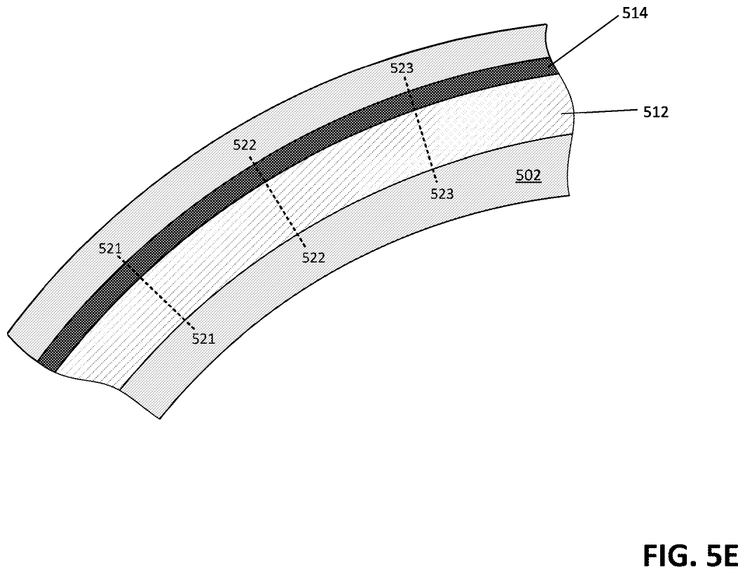

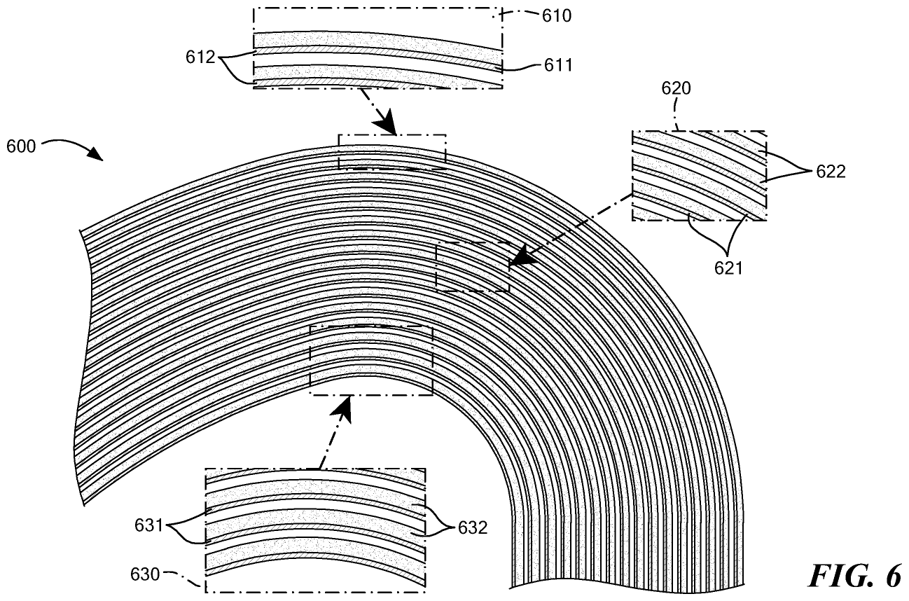

As such, illustrative winding 400 comprises more HTS tape in the outermost turns of the winding than in the middle turns of the same winding. One way to implement this arrangement is to wind some HTS tapes starting from positions within the winding (e.g., 2-4 turns in from the outermost turn). HTS tapes can be included in a stepwise fashion in this way to gradually transition the number of HTS tapes from a first number (e.g., a minimum number of HTS tapes) at the outermost turn of the winding, to a larger number of HTS a few turns in from the outermost turn. An illustrative example of this approach is shown in FIGS. 5A-5B.

FIG. 5A depicts a zoomed in section of portions of four turns of a winding, and FIG. 5B depicts the side of the tapes along the length, showing the stepped nature of the HTS tape when arranged in the manner shown in FIG. 5A.

In the example of FIG. 5A, at each of the points labeled 501, a new or additional piece of HTS tape is added and included in subsequent windings, thereby gradually increasing the number of HTS tapes in the stack along the winding.

As shown in the example of FIG. 5B, a winding 510 may be formed from an HTS tape stack that includes more tapes in the middle portion than at either end. Consequently, if this tape stack were wound to create a winding of a magnet, the number of tapes in a cross-section of at least a portion of the winding at a first end 510a (e.g., inner end) of the winding would be less than the number of tapes in a cross-section in at least a portion of a middle of the winding 510b, and the number of tapes in a cross-section of at least a portion of the winding at a second end 510c (e.g., outer end) would be greater than that in the cross-section at the first end and less than that in the cross-section in the middle.

Alternatively, or additionally to the approach shown in FIGS. 5A-5B, the amount of HTS tape may be varied in some embodiments by joining or otherwise coupling pieces of HTS tape end-to-end with pieces of non-HTS tape. Thus, a single tape may be wound along the whole winding, but only one or more portions of that tape winding may be formed from HTS tape.

In some cases, a winding of a magnet may be formed from a stack of a fixed number of tapes, wherein each tape in the stack of tapes is formed from one of: (i) only HTS tape (which may comprise a single continuous piece of HTS tape, or may comprise multiple pieces of HTS tape coupled end-to-end); (ii) one or more regions of HTS tape coupled end-to-end with one or more regions of non-HTS tape; or (iii) only non-HTS tape. The non-HTS tape may include tape formed from any conventional conductor, including copper tape, or tape formed from a conductive metal alloy, such as a nickel alloy (e.g., Hastelloy®, which is a nickel alloy comprising nickel, iron, chromium and molybdenum). In some embodiments, non-HTS tape may comprise a conductive metal alloy plated with one or more other materials such as other metals and/or metal alloys (e.g., solder). For instance, the non-HTS tape may be prepared in the same or similar manner as the HTS tape shown in FIG. 11, except with a layer of a conventional conductor being used in place of the HTS layer 1110, so that the non-HTS tape comprises for example a buffer layer and copper and silver layers arranged above and below the non-HTS conductor layer.

FIGS. 5C-5E depict an example of a fixed number of tapes being combined to form a winding, according to some embodiments. In the example of FIGS. 5C-5E, a winding is formed from a stack of tapes 512 that extend into the page (generally along the y-direction as defined by the coordinate system shown in FIG. 5C). As with the example of FIG. 3, a channel (not labelled in FIG. 5C) in a baseplate 502 may have disposed therein HTS material (which may form some or all of the stack of tapes 512, as described below), in addition to solder 514 and a cap 516.

As a result of varying the type of tapes in the stack of tapes 512 from which the winding is formed, cross-sections taken at different points along a length of the stack of tapes (where the “length” of the stack of tapes is in the y-direction as defined by the coordinate system of FIG. 5C) may contain different numbers of HTS tapes. This is illustrated, for example, in FIG. 5D.

As illustrated in FIGS. 5D and 5E, cross-sections 521, 522 and 523 through the stack of tapes each contain different numbers of HTS tapes (as indicated by the number of dashed lines representing HTS tape present at that cross-section). FIG. 5E depicts the winding shown in FIG. 5C from above, without the cap 516 shown, so that the cross-sections 521, 522 and 523 through the stack of tapes 512 may be identified.

According to some embodiments, a number of HTS tapes in a first cross-section of the stack of tapes 512 may be greater than a number of HTS tapes in a second cross-section of the stack of tapes. For example, as shown in FIG. 5D, the number of HTS tapes present in the stack of tapes in the cross-section 521 is higher than the number of HTS tapes present in the stack of tapes in the cross-section 523, which contains more filler tape than the cross-section 521 (at which the stack is mostly formed from HTS tapes, but for the co-conductor tapes).

Illustrative materials for each of the tapes in the stack of tapes forming the winding are shown in the graph 520 (FIG. 5D). As can be seen from graph 520, each of the tapes in the stack 512 are formed from one of: a co-conductor (e.g., copper) tape (such as illustrated by the tapes identified by reference numerals 530a and 530b at the top and bottom of the stack, respectively), an HTS tape (such as the uppermost tape comprising HTS and identified by reference numeral 532), or a tape comprising one or more lengths of HTS tape joined end-to-end with a “filler” tape (a filler tape may also be referred to herein as a non-HTS tape), which may be formed from the same or a different material than the co-conductor tape. For example, the filler tape may comprise, or may consist of, a nickel alloy, whereas the co-conductor tape may comprise, or may consist of, a copper tape. As may be noted from graph 520, in some cases a tape stack may comprise a tape formed from multiple separate sections of HTS tape with filler tape arranged in between the sections, and another tape formed from mostly HTS tape with a small section of filler tape joined to the HTS tape (illustrated by the tape identified by reference numeral 534). In some cases, one of the tapes in the stack of tapes may comprise more non-HTS tape (filler tape) than HTS tape (illustrated by the tape identified by reference numeral 535).

A winding formed from a fixed number of tapes may facilitate a simpler winding process compared with adjusting the number of tapes as in the example of FIG. 5A. For instance, a winding process may first splice HTS and filler tape sections together and place the resulting tapes on separate spools. In some embodiments, a typical winding may include in the range of about 100 to about 200 tapes, each requiring a separate spool. The tapes are drawn from all the spools together, bundled into a stack and inserted into the groove in the structural plate. In embodiments, a winding may include fewer than 100 or more than 200 tapes.

According to some embodiments, tape comprising both HTS tape and non-HTS (filler tape) may be produced at least in part by splicing together a portion of HTS tape and a portion of non-HTS tape. Such a splicing operation may comprise soldering, spot welding (e.g., resistance welding) and/or ultrasonic welding.

Returning to FIG. 4, as shown in inset 430, the amount of HTS tape in the innermost several windings is also reduced compared with the pre-grading example, while the amount of HTS tape in the middle winding remains the same. For example, an excess of HTS tape 431 may be seen around the sides of the graded tape stack 432, whereas no such excess is shown around graded tape stack 422, which remain the same size as the pre-graded tape stack. In some embodiments, the innermost turns (e.g., as shown in inset 430) may comprise less HTS tape than the outermost turns (e.g., as shown in inset 410) due to a higher critical current being observed in the innermost turns prior to tape grading.

The approach to tape grading shown in FIG. 4 may be particularly beneficial in an outermost winding in a stack of windings (e.g., in the uppermost or lowermost winding shown in FIG. 2A), which may, without tape grading, tend to exhibit higher critical currents in the innermost and outermost turns of its winding.

It will be appreciated that while FIG. 4 depicts thinner and wider regions of the winding 400, this is intended to convey that the amount of HTS tape in these regions has been reduced. It is not necessarily the case that the stack of tapes is narrower or wider in these sections, given that one approach to reduce the amount of HTS tapes is to splice HTS tape together with filler tape, as shown in FIG. 5C. In some cases, however, the stack of tapes may indeed be narrower in these sections, if the approach of FIG. 5A is followed where HTS tapes are added at particular locations along the winding. As such, FIG. 4 may be understood to convey a varying amount of HTS tape along a winding, irrespective of whether the techniques of FIG. 5A or FIG. 5C (or some other technique) is utilized to produce such a variation.

FIG. 6 depicts an illustrative winding in which a number of HTS tapes are decreased across all turns of a winding, according to some embodiments. It has been recognized by the inventors that the critical current in a winding in the middle of a stack of windings may be much higher (e.g., three times higher) than the critical current in a uppermost or lowermost winding in the same stack of windings. To flatten (or substantially flatten) the critical current across the magnet, a significant reduction in the critical current in the middle windings may be desirable. FIG. 6 is an example of such an approach, which shows a constant amount of HTS tape around the entire winding 600 before grading (encompassing the regions shaded with diagonal lines and the regions shaded with dots), and shows an approximately constant, and much reduced, amount of HTS tape in the regions shaded with diagonal lines only, after grading. As shown by each of the insets 610, 620 and 630 of FIG. 6, the amount of HTS tape in the outermost, innermost, and middle windings is reduced compared with the pre-grading amount of HTS tape. For example, a reduction of the amount of HTS tape 611, 621 and 631 may be seen in the graded tape stack at 612, 622 and 632. The insets 610, 620 and 630 are not drawn to the same scale as one another.

It will be appreciated that while FIG. 6 depicts regions of the winding 600 that are thinner after grading, this is intended to convey that the amount of HTS tape in these regions has been reduced. It is not necessarily the case that the stack of tapes in the winding is narrower in these sections, given that one approach to reduce the amount of HTS tapes is to splice the HTS tape together with filler (non-HTS) tape, as described herein at least in conjunction with FIGS. 5C-5E. In some cases, however, the stack of tapes may indeed be narrower in these sections, if the approach of FIG. 5A is followed where HTS tapes are added at particular locations along the winding. As such, FIG. 6 may understood to convey a reduced amount of HTS tape around a winding, irrespective of whether the techniques of FIG. 5A or FIG. 5C (or some other technique) is utilized to produce such a variation.

Having described techniques for tape grading, techniques for turn-to-turn resistance grading are now described below. As described above, adjusting the spacing between turns of a non-insulated magnet may adjust the resistance between the turns and thereby adjust the joule heating rates of each turn. This adjustment may allow a magnet to be tuned so that quenches occur more uniformly across the magnet.

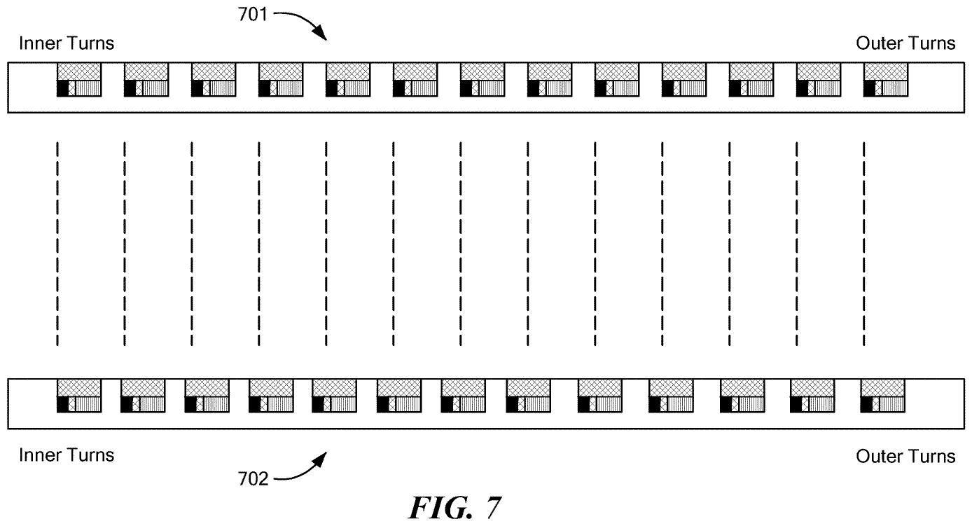

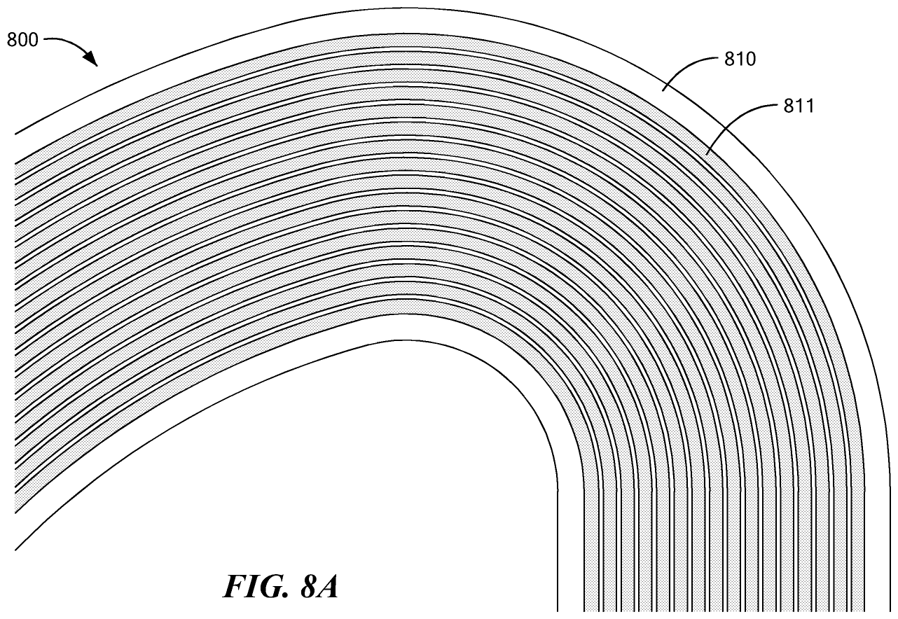

An illustrative example of turn-to-turn resistance grading is shown in FIG. 7, according to some embodiments. In the example of FIG. 7, a cross-sectional view through a winding within a structural plate 701 is depicted, which exhibits conventional, equally sized gaps between adjacent winding turns. As shown, the amount of the structural plate between adjacent turns is constant, leading to an equal spacing between each turn. In contrast, the winding in structural plate 702 has a gap between adjacent turns that varies. This is highlighted in FIG. 7 by the vertical dashed lines, which are evenly spaced and show that the spacing between the inner turns in winding in structural plate 702 has been reduced compared with winding in structural plate 701, and that the spacing between the outer turns in winding in structural plate 702 has been increased compared with winding in structural plate 701. The net result is that the same number of turns in both 701 and 702 occupy the same total amount of space, but with a smaller spacing in one region and a larger spacing in another region.

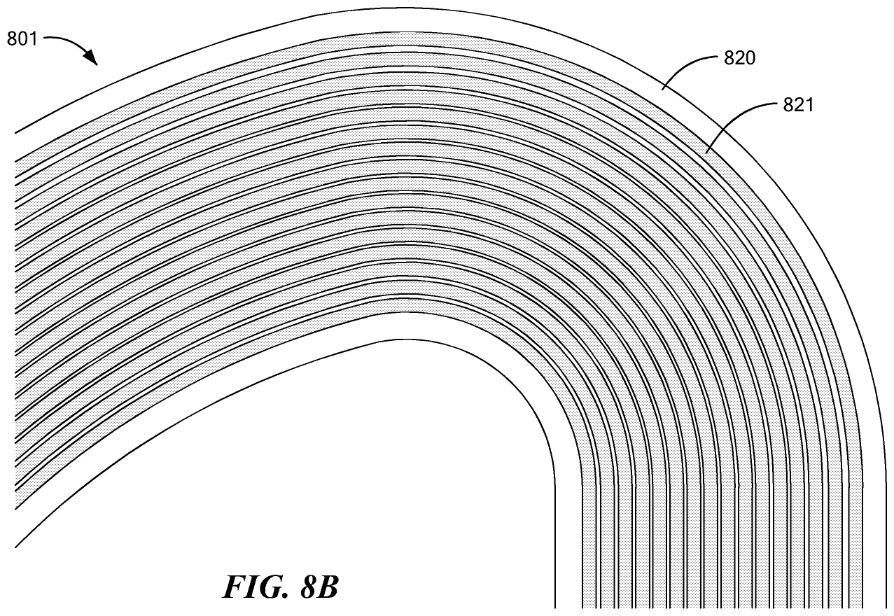

Structural plates without, and with, this turn-to-turn resistance grading, are shown in FIGS. 8A and 8B, respectively, according to some embodiments. In the example of FIG. 8A, a structural plate 800 is shown formed from a baseplate 810 in which a groove 811 is formed. As shown, the spacing between each turn of the groove is constant. In contrast, structural plate 801 shown in FIG. 8B includes a baseplate 820 and groove 821 in which the spacing between turns of the grooves varies, from a smaller spacing in the inner turns, to a larger spacing in the outer turns. Both structural plates 800 and 801 include a groove with 16 turns, but in plate 801 the grooves are arranged closer together in some turns compared with other turns.

It has been recognized by the inventors that the volume of inner turns in a grooved structural plate is smaller than the volume of outer turns in the plate, and that consequently arranging the inner turns closer together to one another than the outer turns are to one another would make the turn-to-turn resistance more constant across the turns. As such, there may be a particular benefit in arranging the turn-to-turn distances between grooves in a structural plate as shown in FIG. 8B.

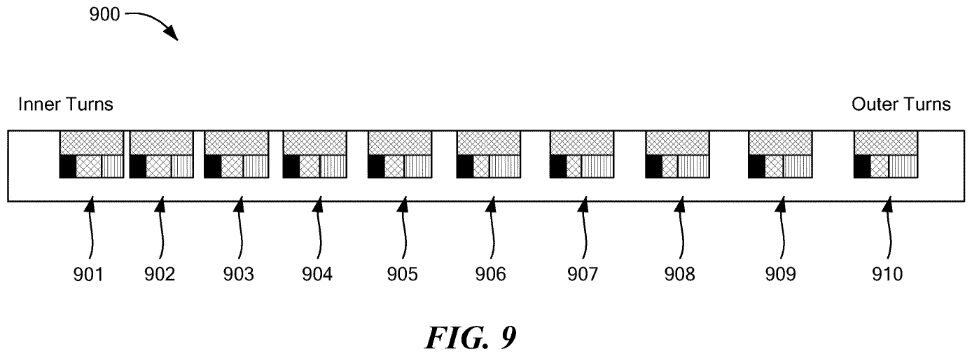

According to some embodiments, the techniques of turn-to-turn resistance grading may be applied along with tape grading techniques. An illustrative example of the result of applying such an approach is shown in FIG. 9, according to some embodiments. In the example of FIG. 9, the winding in structural plate 900 includes ten turns 901-910. The structural plate is formed so that inner turns (e.g., 901, 902) have a turn-to-turn spacing that is less than the turn-to-turn spacing of the outer turns (e.g., 909, 910). In addition, the amount of HTS tape in each turn varies across the turns, with the turn 901 comprising the least amount of HTS tape, turns 906 and 907 comprising the highest amount of HTS tape, and turns 909 and 910 comprising less HTS tape than turns 906 and 907, but more HTS tape than turn 901. In this way, winding in structural plate 900 may be an example of an outer structural plate in a stack of plates such as that depicted by FIG. 4, with the addition of turn-to-turn resistance grading applied. In general, any suitable combination of tape grading and turn-to-turn resistance grading may be applied to a given winding, and the example of FIG. 9 is shown merely as one illustrative approach.

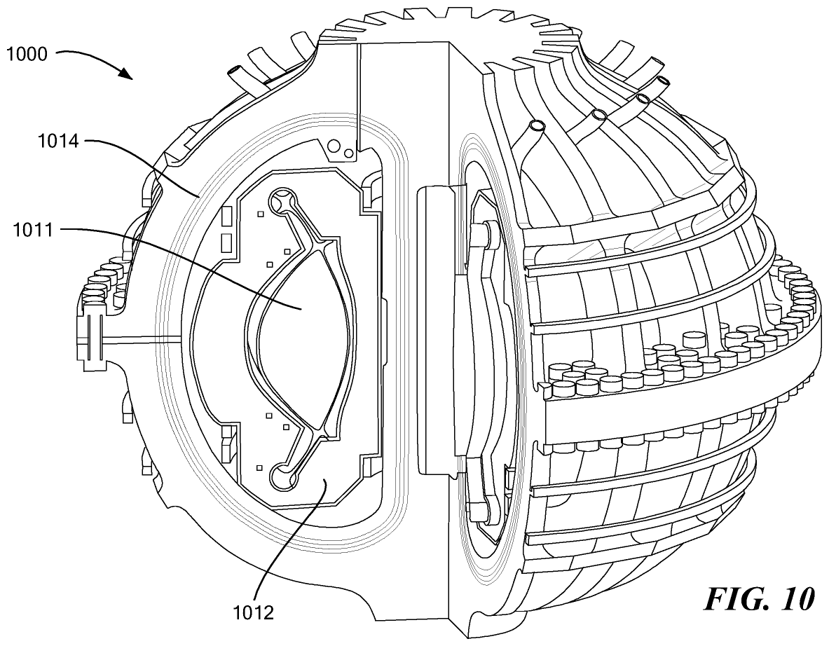

FIG. 10 is a three-dimensional graphic of a fusion machine with a cutaway portion illustrating various components of a tokamak, according to some embodiments. A magnet within a fusion machine may be formed from a stack of windings arranged within structural grooves of a structural plates arranged in a stack, as described above. FIG. 10 shows a cross-section through a fusion machine 1000 and includes a magnet coil 1014, which is fabricated from, or otherwise includes, a stack of windings arranged within structural grooves of a structural plates arranged in a stack as described above, a neutron shield 1012, and a core region 1011. According to some embodiments, the magnet coil 1014 may be, or may form part of, a toroidal field coil.

Persons having ordinary skill in the art may appreciate other embodiments of the concepts, results, and techniques disclosed herein. It is appreciated that superconducting magnets configured according to the concepts and techniques described herein may be useful for a wide variety of applications. For instance, one such application is conducting nuclear magnetic resonance (NMR) research into, for example, solid state physics, physiology, or proteins. Another application is performing clinical magnetic resonance imaging (MRI) for medical scanning of an organism or a portion thereof, for which compact, high-field magnets are needed. Yet another application is high-field MRI, for which large bore solenoids are required. Still another application is for performing magnetic research in physics, chemistry, and materials science. Further applications is in magnets for particle accelerators for materials processing or interrogation; wind power generators and other electrical power generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, processes, and techniques disclosed herein may be put without deviating from their scope.

As used herein, the phrases “HTS material,” “HTS superconductor material” or “HTS superconductor” refer to a superconducting material having a critical temperature above 30° K at zero self-field.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Additional aspects of the present disclosure may include:

Aspect 1. A high-temperature superconducting (HTS) magnet comprising: a coil formed from a stack of HTS tape, the coil having at least one bend; at least one additional layer of HTS tape positioned along a portion of the coil to increase the width of the portion of the coil.

Aspect 2. The magnet of aspect 1 wherein the at least one additional layer of HTS tape comprises a plurality of HTS tapes, each tape having an end that is offset from an end of an adjacent tape to form a tapered width of the portion of the coil.

Aspect 3. The magnet of aspect 1 wherein the HTS tape is positioned along the bend.

Aspect 4. The magnet of aspect 3 wherein the at least one additional HTS tape is positioned along an outer circumference of the stack of HTS tape.

Aspect 5. The magnet of aspect 1 wherein the HTS magnet comprises a stack of pancake magnets, each pancake magnet comprising a respective coil formed from a stack of HTS tape.

Aspect 6. The magnet of aspect 5 wherein at a plurality of the coils include additional layers of HTS tape to increase the width of the stack of HTS tape along portions of the coil.

Aspect 7. The magnet of aspect 1 wherein the at least one additional layer of HTS tape has a length that is shorter than a length of the coil.

Aspect 8. A high-temperature superconducting (HTS) pancake magnet comprising: a baseplate formed from a conductive material, the baseplate having a groove with multiple turns; a coil formed from HTS material, the coil positioned within the groove, the coil having multiple turns, wherein the HTS material is positioned within the groove; wherein the radial distance between adjacent turns of the coil of HTS material is variable.

Aspect 9. The magnet of aspect 8 wherein the baseplate of the pancake forms a shape having an inner diameter and an outer diameter.

Aspect 10. The magnet of aspect 9 wherein the distance between adjacent turns of the coil that are closer to the inner diameter is smaller than the distance between adjacent turns of the coil that are closer to the outer diameter.

Aspect 11. A high-temperature superconducting (HTS) magnet comprising: a coil formed from a plurality of windings, the plurality of windings comprising HTS tape, wherein the plurality of windings include: a first portion comprising a first stack of HTS tapes having a first thickness, a second portion arranged exterior to the first portion and comprising a second stack of HTS tapes having a second thickness greater than the first thickness, and a third portion arranged exterior to the first and second portions and comprising a third stack of HTS tapes having a third thickness less than the second thickness.

Aspect 12. The HTS magnet of aspect 11, wherein: the first portion of the plurality of windings includes a plurality of inner turns of the plurality of windings, the third portion of the plurality of windings includes a plurality of outer turns of the plurality of windings, and the second portion of the plurality of windings includes one or more windings between the plurality of inner turns and plurality of outer turns.

Aspect 13. The HTS magnet of aspect 11, wherein the plurality of windings include at least one HTS tape that is arranged within the second portion of the plurality of windings and is not arranged within the first portion of the plurality of windings or the third portion of the plurality of windings.

Aspect 14. The HTS magnet of aspect 11, wherein the plurality of windings further comprise a co-conductor arranged in contact with the HTS tape.

Aspect 15. The HTS magnet of aspect 14, wherein an amount of the co-conductor increases and decreases within the plurality of windings.

Aspect 16. The HTS magnet of aspect 15, wherein the plurality of windings have a constant, or substantially constant thickness.

Aspect 17. The HTS magnet of aspect 11, further comprising a baseplate formed from a conductive material and comprising a groove with multiple turns, and wherein the groove includes: a first portion having a first width and comprising the first portion of the plurality of windings; a second portion having a second width, greater than the first width, and comprising the second portion of the plurality of windings; and a third portion having a third width, smaller than the second width, and comprising the third portion of the plurality of windings.

Aspect 18. The HTS magnet of aspect 11, wherein the first portion of the plurality of windings forms less than one complete turn of the coil.

Aspect 19. The HTS magnet of aspect 11, wherein the third portion of the plurality of windings forms less than one complete turn of the coil.

Aspect 20. A high-temperature superconducting (HTS) magnet comprising: a coil formed from a plurality of windings, the plurality of windings comprising a stack of HTS tape, wherein the plurality of windings includes an HTS tape that forms less than one complete turn of the coil.

Aspect 21. The HTS magnet of aspect 18, wherein the plurality of windings further comprise a co-conductor arranged in contact with the stack of HTS tape.

The above-described embodiments of the technology described herein can be implemented in any of numerous ways. Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within =20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A high-temperature superconductor (HTS) magnet comprising:
a coil formed from a plurality of windings, a first winding of the plurality of windings comprising a first portion of HTS tape that forms less than one complete turn of the coil.

2. The HTS magnet of claim 1, wherein the first portion of HTS tape is coupled end-to-end with one or more portions of a non-HTS tape formed from a conductive metal or conductive metal alloy.

3. The HTS magnet of claim 2, wherein a combination of the first portion of HTS tape and the one or more portions of the non-HTS tape form a full winding of the coil.

4. The HTS magnet of claim 3, wherein the first winding comprises a plurality of tapes that each form a complete turn of the coil and that are each formed from one or more portions of HTS tape coupled end-to-end with one or more portions of non-HTS tape.

5. The HTS magnet of claim 4, wherein the plurality of tapes further comprise one or more co-conductor tapes.

6. The HTS magnet of claim 1, wherein the first winding further comprises a co-conductor arranged in contact with the first portion of HTS tape.

7. The HTS magnet of claim 6, wherein the co-conductor is a co-conductor tape arranged in contact with the first portion of HTS tape.

8. A high-temperature superconductor (HTS) magnet comprising:
a coil formed from a plurality of windings, the plurality of windings comprising a first winding formed from a stack of tapes, wherein:
the stack of tapes comprises a first number of HTS tapes at a first cross-section,
the stack of tapes comprises a second number of HTS tapes, greater than the first number of HTS tapes, at a second cross-section exterior to the first cross-section around the first winding, and
the stack of tapes comprises a third number of HTS tapes, less than the second number of HTS tapes, at a third cross-section exterior to the second cross-section around the first winding.

9. The HTS magnet of claim 8, wherein the stack of tapes at the first cross-section has a first thickness, wherein the stack of tapes at the second cross-section has a second thickness, greater than the first thickness, and wherein the stack of tapes at the third cross-section has a third thickness, less than the second thickness.

10. The HTS magnet of claim 8, wherein the stack of tapes comprises a stack of HTS tapes and a plurality of portions of non-HTS tape formed from a conductive metal or conductive metal alloy.

11. The HTS magnet of claim 10, wherein at least some of the portions of non-HTS tape are joined end-to-end with portions of HTS tape.

12. The HTS magnet of claim 8, wherein:
the first cross-section is in an inner turn of the first winding,
the third cross-section is in an outer turn of first winding, and
the first winding includes a plurality of turns between the inner turn and the outer turn.

13. The HTS magnet of claim 8, wherein the first winding includes a first portion of HTS tape that is present at the second cross-section and is not present at the first cross-section or the third cross-section.

14. The HTS magnet of claim 13, wherein the first portion HTS tape is coupled end-to-end with a non-HTS tape formed from a conductive metal or conductive metal alloy.

15. The HTS magnet of claim 8, wherein the stack of tapes comprises one or more co-conductor tapes.

16. The HTS magnet of claim 15, wherein a number of the co-conductor tapes increases and decreases within the first winding.

17. The HTS magnet of claim 16, wherein the first winding has a constant, or substantially constant, thickness.

18. (canceled)

19. The HTS magnet of claim 8, wherein the first, second and third cross-sections are within different turns of the first winding.

20. (canceled)

21. (canceled)

22. (canceled)

23. (canceled)

24. (canceled)

25. (canceled)

26. (canceled)

27. A high-temperature superconductor (HTS) magnet comprising:
a coil formed from a stack of HTS tape, the coil having at least one bend; and
at least one additional layer of HTS tape positioned along a portion of the coil to provide the coil having an amount of HTS material which is increased compared with an amount of HTS material in a second, different portion of the coil.

28. The magnet of claim 27, wherein the at least one additional layer of HTS tape comprises a plurality of HTS tapes, each tape having an end that is offset from an end of an adjacent tape to form a tapered thickness of the portion of the coil.

29. The magnet of claim 27, wherein the HTS tape is positioned along the bend.

30. The magnet of claim 29, wherein the at least one additional layer of HTS tape is positioned along an outer circumference of the stack of HTS tape.

31. The magnet of claim 27, wherein the HTS magnet comprises a stack of pancake magnets, each pancake magnet comprising a respective coil formed from a stack of HTS tape.

32. The magnet of claim 31, wherein at least one of the coils include additional layers of HTS tape to increase a thickness of the stack of HTS tape along portions of the coil.

33. The magnet of claim 27, wherein the at least one additional layer of HTS tape has a length that is shorter than a length of the coil.

34. (canceled)

35. (canceled)

36. (canceled)
